(19) United States
(12) Patent Application Publication
(10) Pub. No.: US 2011/0079566 A1
(43) Pub. Date: Apr. 7, 2011

(54) DISPLAY APPARATUS

(75) Inventors: Masaya NAKAMICHI, Kizugawa-shi (JP); Shohei TAKAHASHI, Osaka (JP)

(73) Assignee: SANYO ELECTRIC CO., LTD., Osaka (JP)

(21) Appl. No.: 12/894,504

(22) Filed: Sep. 30, 2010

(30) Foreign Application Priority Data
Sep. 30, 2009 (JP) 2009-226908

(51) Int. Cl. F16M 13/00

(52) U.S. Cl. 211/85.26

(57) ABSTRACT

A display apparatus includes a support base supporting a housing accommodating a display panel. The support base includes a pair of first components extending in a generally vertical direction on both sides of the housing and a second component extending in a generally horizontal direction along a top surface of the housing. Each of the first components and the second component are connected in an L-shape by a connector. The connector includes an abutting member contacting both rear surfaces of one of the first components and the second component to be connected, a first screw member passing through the one of the first components contacting the abutting member to be screwed into the abutting member, and a second screw member passing through the second component contacting the abutting member to be screwed into the abutting member. The housing is attached to the pair of first components and/or the second component.

The Japanese patent application Number 2009-226908, upon which this patent application is based, is hereby incorporated by reference.

### BACKGROUND OF THE INVENTION

1. Field of the Invention

The present invention relates to a display apparatus with an image display panel.

2. Description of Related Art

In recent years, flat panel display apparatuses for outdoor installation have appeared.

In such an apparatus, in order to protect the panel (such as a liquid crystal panel) from weather, dust and the like, there is considered arranging the panel inside an accommodation chamber having a sealed structure. Also, in order to install the apparatus on the ground or on a floor, there is considered supporting a housing by a metal support base. Here, the metal support base can be made by connecting a plurality of components of the base by welding.

The support base which supports the housing is required to have high strength at the welded portions between the components of the base. However, in order to fortify the strength of the welded portions between the components, a high welding technique is required. Further, at the welded portions, a part of the components may fuse and a surface of the components may swell. When the surface of the support base is required to be flat, such swell should be removed, however this may decrease the strength of the welded portions.

### SUMMARY OF THE INVENTION

A display apparatus according to the present invention comprises a display panel, a housing which accommodates the display panel, and a support base which supports the housing, and the housing is provided with an image display window which makes a screen of the panel viewable from outside. The support base comprises a pair of first components extending in a generally vertical direction on both sides of the housing, and a second component extending in a generally horizontal direction along a top surface of the housing. Each of the first components and the second component are connected in an L-shape by a connector. The connector comprises an abutting member which contacts both rear surfaces of one of the first components and the second component to be connected, a first screw member which penetrates the one of the first components and is screwed into the abutting member, and a second screw member which penetrates the second component and is screwed into the abutting member. The housing is attached to the pair of first components and/or the second component.

### BRIEF DESCRIPTION OF THE DRAWINGS

FIG. 1 is a perspective view of a display apparatus in accordance with an embodiment of the present invention seen from a front side;

FIG. 2 is an exploded perspective view of a support base included in the display apparatus;

FIG. 3 is a perspective view for explaining a structure of a connector included in the display apparatus; and

FIG. 4 is a perspective view of the support base in an assembled state.

### DETAILED DESCRIPTION OF THE PREFERRED EMBODIMENT

A display apparatus according to a preferred embodiment of the present invention is discussed in detail below with reference to drawings.

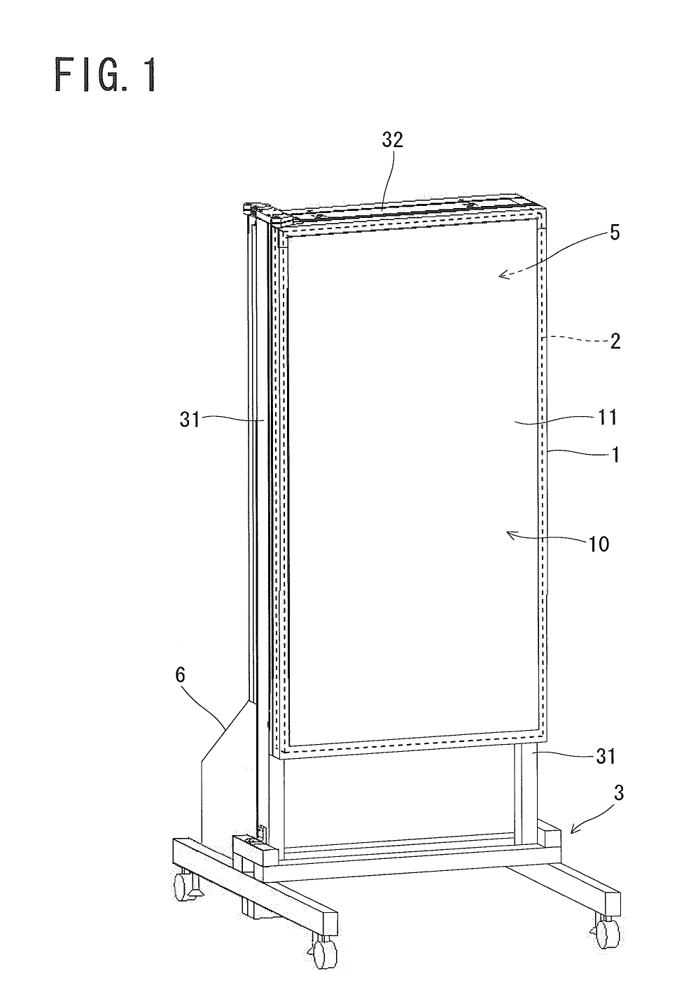

As shown in FIG. 1, the display apparatus comprises a housing 1, a liquid crystal display panel 2 arranged in the housing 1, a support base 3 for supporting the housing 1, and a cooling device 6. The panel 2 includes a light emitting diode (LED) as a light source for image display. The base 3 is provided with casters attached thereto.

The housing 1 includes therein an accommodation chamber 5 having a sealed structure. A front wall of the chamber 5 is formed by a front wall 11 of the housing 1, and the front wall is made of an optically transparent material such as a glass material. In contrast, an upper wall, a bottom wall, both side walls and a rear wall of the chamber 5 are made of a metal such as aluminum or the like.

The panel 2 is accommodated in the chamber 5, and a screen of panel 2 faces the front wall of the chamber 5, i.e.

the front wall 11 of the housing 1. Thus, a part of the front wall 11 of the housing 1 which faces the screen of the panel 2 forms an image display window 10, and the screen of the panel 2 can be viewed from outside through the window 10.

The air inside the chamber 5 is circulated around the panel 2 by operation of a fan device (not shown in the figures). Also, the cooling device 6 comprises an evaporator for collecting heat inside the chamber 5 and a condenser for releasing the heat collected by the evaporator. Thus, the air circulating inside the chamber 5 is cooled by the device 6.

In the display apparatus, since the panel 2 is accommodated in the chamber 5 having a sealed structure, even when the apparatus is installed outside, the panel 2 is protected from weather, dust and the like.

On the other hand, heat generated from the panel 2 stays inside the chamber 5, and thus, the temperature in the chamber 5 tends to rise. Therefore, the air inside the chamber 5 is cooled by the device 6. Thus, the temperature increase inside the chamber 5 is inhibited, and the function of the panel 2 is maintained in normal state.

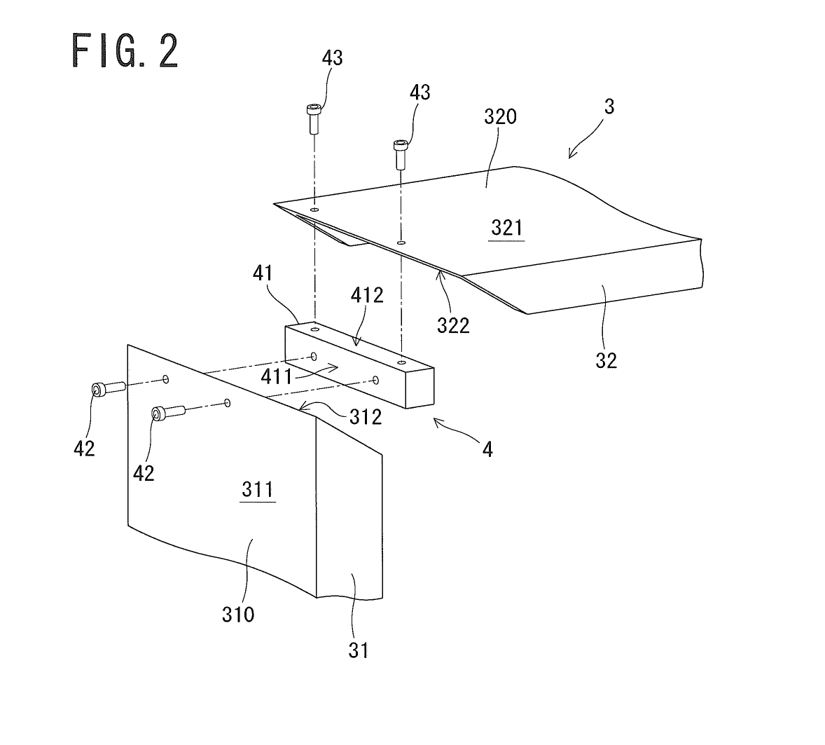

As shown in FIG. 1, the base 3 includes a right and left pair of first components 31, 31 extending in a generally vertical direction on both sides of the housing 1, and a second component 32 extending in a generally horizontal direction along a top surface of the housing 1. Each of the components 31, 31 and the component 32 is formed by a metal plate of aluminum formed to have a U-shaped cross section as shown in FIG. 2. The housing 1 is attached to the components 31, 31 and/or the component 32.

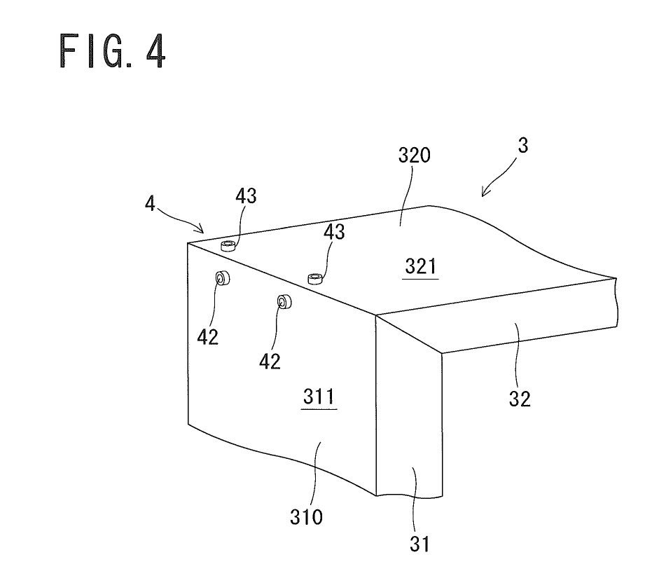

One of the components 31 and the component 32 are connected in an L-shape as shown in FIG. 4. Specifically, as shown in FIG. 2, each of the components 31 and the component 32 are connected in an L-shape by a connector 4 with respective external surfaces 311, 321 of bottom walls 310, 320 thereof facing outside. The other one of the components 31 and the component 32 are connected similarly.

The connector 4 comprises a quadrangular prism-like abutting member 41 having four side surfaces, a pair of first screw members 42, 42 for fixing one of the first components 31 to the abutting member 41, and a pair of second screw members 43, 43 for fixing the second component 32 to the abutting member 41.

Among four side surfaces of the abutting member 41, two side surfaces 411, 412 perpendicular to each other are in contact with the first component 31 and the second component 32 respectively. Specifically, an inner surface 312 of the bottom wall 310 of the first component 31 contacts with one side surface 411 of the abutting member 41, and an inner surface 322 of the bottom wall 320 of the second component 32 contacts with the other side surface 412 of the abutting member 41.

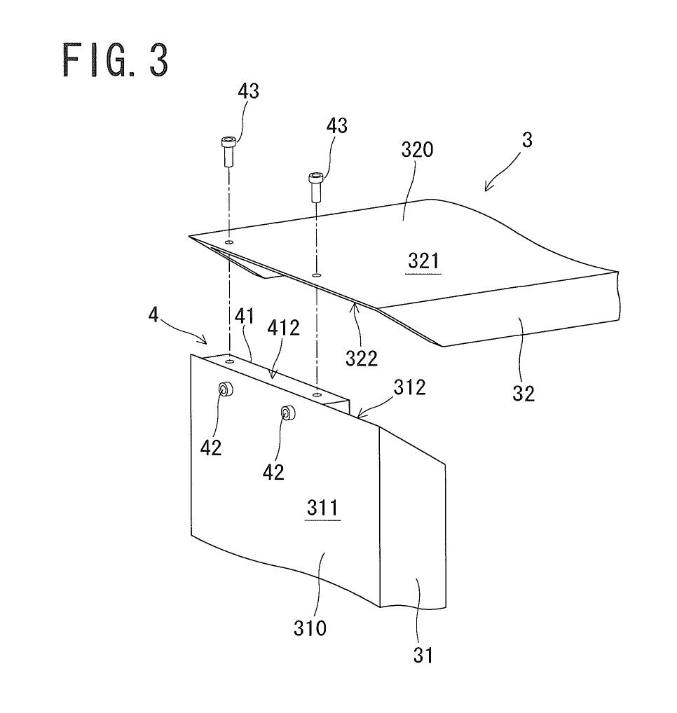

The pair of first screw members 42, 42 penetrates one of the first component 31 and is screwed into the abutting member 41. Thereby, as shown in FIG. 3, the first component 31 is fixed to the abutting member 41.

On the other hand, the pair of second screw members 43, 43 penetrates the second component 32 and is screwed into the abutting member 41. Thereby, as shown in FIG. 4, the second component 32 is fixed to the abutting member 41. The first components 31 and the second component 32 are thus connected in an L-shape by the connector 4.

According to the base 3 described above, the first component 31 and the second component 32 can be easily connected in an L-shape by the connector 4. Therefore, the base 3 can be made easily. Further, the components 31 and 32 can be connected tenaciously, with a simple structure. Accordingly, connections between the first components 31 and the second component 32 are hardly broken when the housing 1 is attached to the base 3. Thus, the base 3 can have a high strength.

Further, both of the first components 31 and the second component 32 of the base 3 have a U-shaped cross section, and thereby the first and second components 31, 32 have high strength. Therefore, the first and second components 31, 32 are hardly deformed even when the housing 1 having a considerable weight is attached to the base 3.

The present invention is not limited to the foregoing embodiment in structure but can be modified variously within the technical range set forth in the appended claims. For example, the number of first screw members 42 of the connector 4 is not limited to two, but can be one, or can be three or more. It is same to the number of second screw members 43 of the connector 4.

The material of the first and second components 31, 32 of the base 3 is not limited to aluminum, and it can be various other metal materials. Further, materials other than metal material can be employed as the material of the components 31, 32.

The first and second components 31, 32 can be formed by metal plates having various cross sections as well as the metal plate having a U-shaped cross section.

The structure employed in the display apparatus described above can be applied not only to the display apparatus having the panel 2, but also to display apparatuses with various image display panels such as a plasma display, or an organic EL (Electro-Luminescence) display.

What is claimed is:

1. A display apparatus comprising:
a display panel;
a housing which accommodates the panel and includes a display window making the panel viewable from outside; and
a support base which supports the housing, wherein the support base comprises:
a pair of first components extending in a vertical direction on both sides of the housing; and
a second component which is connected to each of the first components in an L-shape by a connector and extending in a horizontal direction along a top surface of the housing,
wherein the connector comprises:
an abutting member which contacts both rear surfaces of one of the first components and the second component to be connected;
a first screw member which penetrates the one of the first components and is screwed into the abutting member; and
a second screw member which penetrates the second component and is screwed into the abutting member,
wherein the housing is attached to the pair of first components and/or the second component.

2. The display apparatus according to claim 1, wherein each of the pair of first components and the second component is a metal plate formed to have a U-shaped cross section.
